(19) United States
(12) Patent Application Publication
(10) Pub. No.: US 2013/0115581 A1
(43) Pub. Date: May 9, 2013

(54) MULTI-LEVEL COLOR BASED COMMUNICATION SYSTEM AND METHOD

(71) Applicant: Michael Mancini, Orange Park, FL (US)

(72) Inventor: Michael Mancini, Orange Park, FL (US)

(21) Appl. No.: 13/288,232

(22) Filed: Nov. 3, 2011

(51) Int. Cl. G09B 19/06

(52) U.S. Cl. 434/157

(57) ABSTRACT

A method for performing multi-level color based communication includes the steps of creating a plurality of individual color patterns, associating each of the plurality of individual color patterns with a known language character, and composing a message containing one or more of the individual color patterns.

### BACKGROUND

### Field of the Invention

The present invention relates generally to color based communication, and more particularly to a novel method and system for performing multi-level communication utilizing a color based dictionary.

As the human race has evolved, so have its methods of communication. From strictly verbal words and commands, to paintings on cave walls, to hieroglyphics, and ultimately the alphabet as we know it today, our language and tools for communicating with others continues to evolve. However, there have been only limited attempts to communicate based on color.

Previous known systems have attempted to assign a phonetic meaning to a color. For example, U.S. Pat. No. 6,844,075 is directed to a system for augmenting language constructs via spelling or foreign language tutorials, by associating colors with the traditional representation of the language constructs. To this end, the '075 document, and others like it utilize colors as a redundant means for reinforcing the traditional language constructs.

While these devices fulfill their respective objectives, the above identified documents do not disclose a multi-level color based communication system and method capable of using colors as the primary, and/or only means of conveying information. Accordingly, there remains a need for a method and system capable of delivering multi-level color based communication in a single message.

### SUMMARY OF THE INVENTION

The present invention is directed to a method for performing multi-level color based communication. One embodiment of the present invention can include the steps of creating a plurality of individual color patterns, associating each of the plurality of individual color patterns with a known language character, and composing a message containing one or more of the individual color patterns.

Another embodiment of the present invention can include the steps of composing a message containing a plurality of communication levels, each of said communication levels including one or more individual color patterns.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a color based communication dictionary.

FIG. 2 illustrates another embodiment of a color based communication dictionary using the RGB color model.

FIG. 3 is a chart illustrating the color values of color based communication dictionaries using both the RGB and CMYK color models.

FIG. 4 illustrates the use of color patterns in accordance with one embodiment of the present invention.

FIG. 5 illustrates methods for bi-level communication utilizing the color dictionary in one embodiment of the present invention.

FIG. 6. illustrates another example of multi-level color based communication according to one embodiment of the present invention.

FIG. 7 illustrates methods for multi-level communication utilizing the color dictionary in one embodiment of the present invention.

FIG. 8 is a flow chart illustrating one embodiment of a system for performing multi-level color based communication.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although the proceeding examples and description utilize the English alphabet, one of skill in the art will readily understand that the present invention can be equally applied to any language and/or alphabet system.

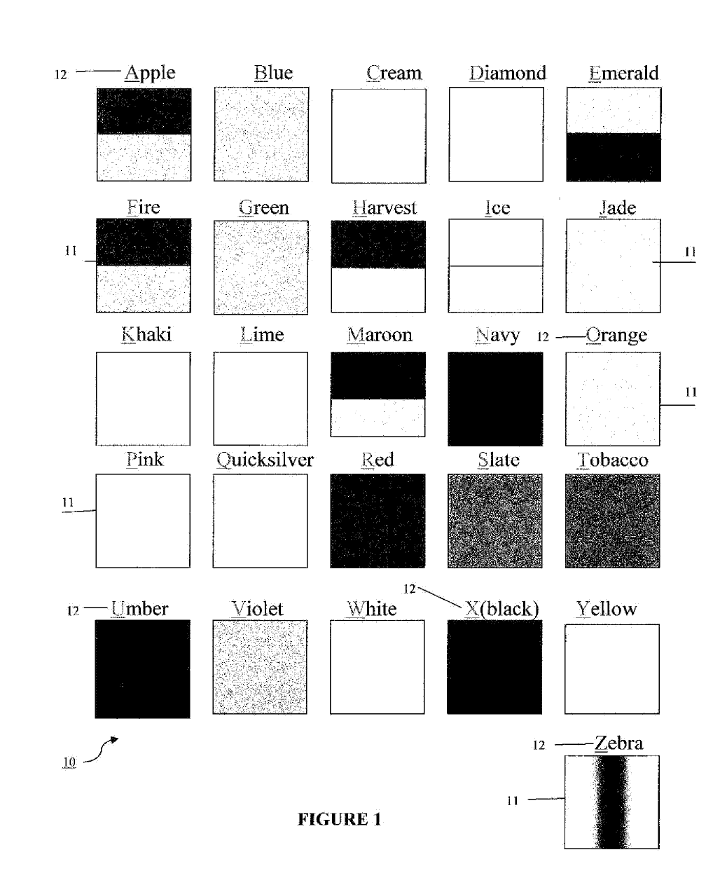

FIGS. 1-3 illustrate one embodiment of a color based communication dictionary 10 (i.e., color-chat), that is useful for understanding the inventive concepts disclosed herein. As shown in FIG. 1, the color-chat dictionary 10 can include a plurality of specific and distinct color patterns 11 that each represent a single letter of a traditional alphabet 12. As described herein, each color pattern 11 can include a single color or a combination of distinct colors, which act in unison to represent a specific alphabet letter 12. Additionally, the alphabet letter 12 to which the specific color pattern represents can be underlined, and can also be the first letter of a word which describes the color pattern 11 itself.

For example, as shown in FIG. 1, a single word such as “Apple, Blue, Cream . . . etc.,” can be placed over each unique color pattern 11. To this end, the first color pattern 11 represents the English alphabet letter “A” and is composed of red and green pigments (i.e., the colors of an apple). The second color pattern represents the English alphabet letter “B” and is composed of the color blue. The third color pattern represents the English alphabet letter “C” and is composed of the color cream, and so on until each letter of the English alphabet (A-Z) have been associated with a unique color pattern 11 and descriptive word.

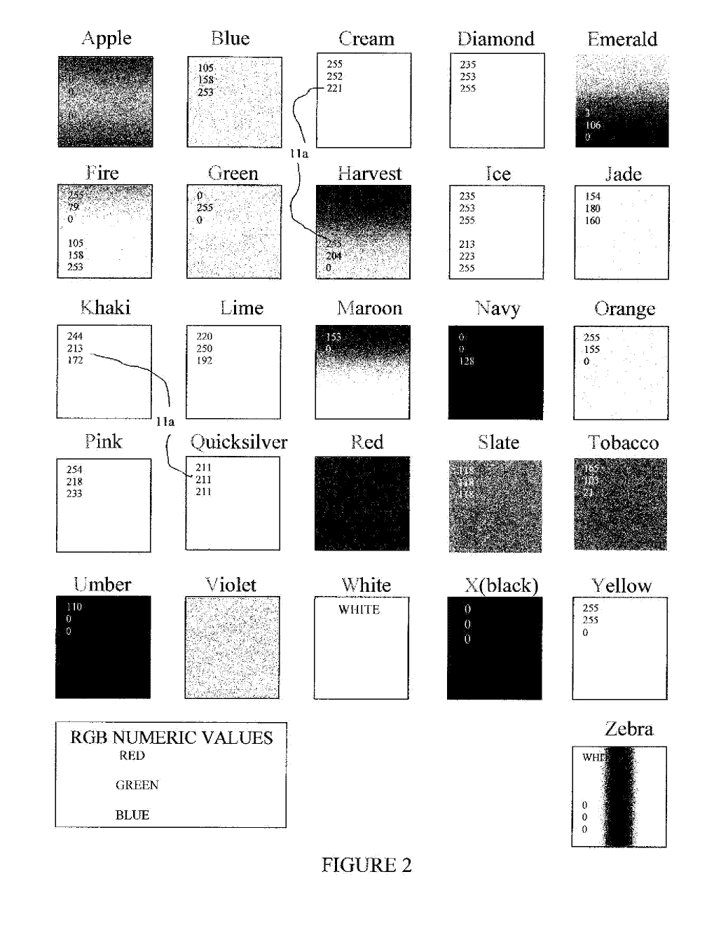

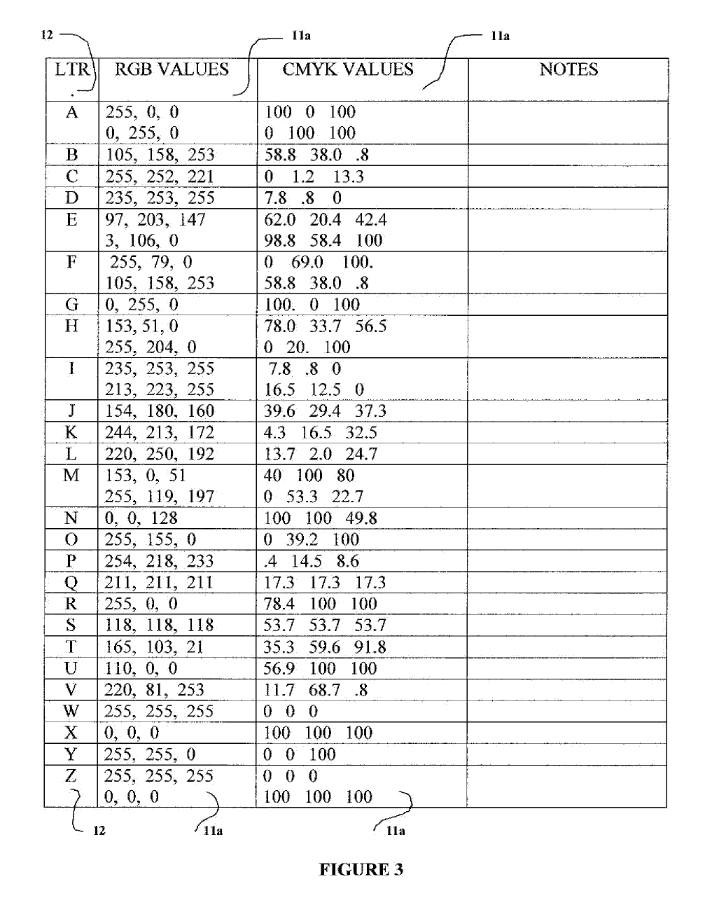

As described herein, no two color patterns 11 in the color-chat dictionary 10 will be the same. Each color pattern 11 in the color-chat dictionary 10 is a consistent, predetermined color or combination of colors. To this end, and as illustrated in FIGS. 2-3, each color pattern 11 can be assigned a unique color code 11a according to known methodologies. One such color code is the RGB color model, which is an additive color model in which the colors red, green and blue are added together in various ratios to produce a broad array of colors. Another color code can include the CMYK color model that uses the colors cyan, magenta, yellow, and black. Each of these color coding methods and corresponding systems are known in the art, therefore no further description will be provided.

Although described above as using colors to represent a single alphabet letter, one of skill in the art will recognize that, with minor alterations and/or additions, the inventive concepts disclosed herein can also be utilized to represent other characters ranging from numbers (e.g., 1, 2, 3 . . . ) to symbols (e.g., ?, . $ % @). Accordingly, the invention is not limited in scope to only alphabet letters.

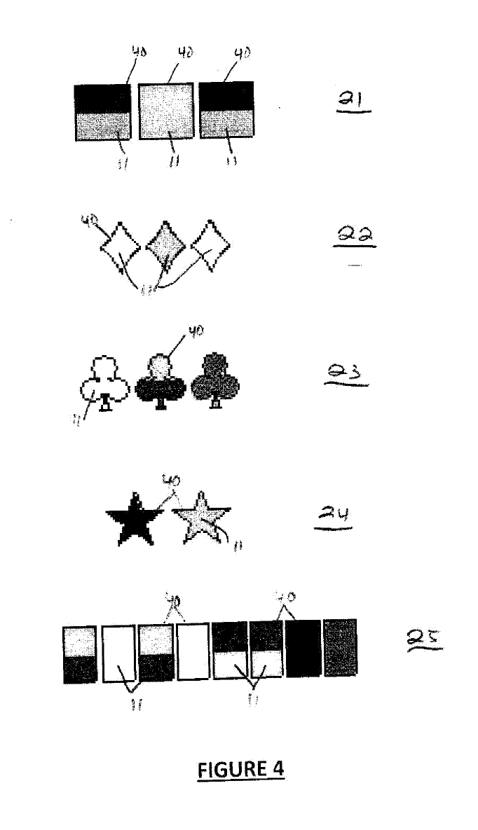

In operation, a user can communicate exclusively by utilizing the color patterns 11 of the color-chat dictionary 10 described above. To this end, the shape of the color pattern 11 is not important, so long as the color pattern itself can be identified. In one embodiment illustrated in FIG. 4, color patterns 11 containing any number of shapes 40 ranging from characters, shapes and such can be utilized to convey information. For example, message 21 can include three shapes 40 each containing a separate color pattern 11 which spells the word “MOM,” when transcribed by the color dictionary 10. Likewise message 22 can spell the word “WOW,” message 23 can spell the word “YES,” message 24 can spell the word “NO,” and message 25 can spell the word “ELEPHANT.”

To this end, by utilizing specific color patterns 11 without requiring a specific shape or character 40, a user can communicate messages and information. In this regard, each individual color pattern 11 can act as a primary method (i.e. first level) of communication with others, without requiring a physical shape or character.

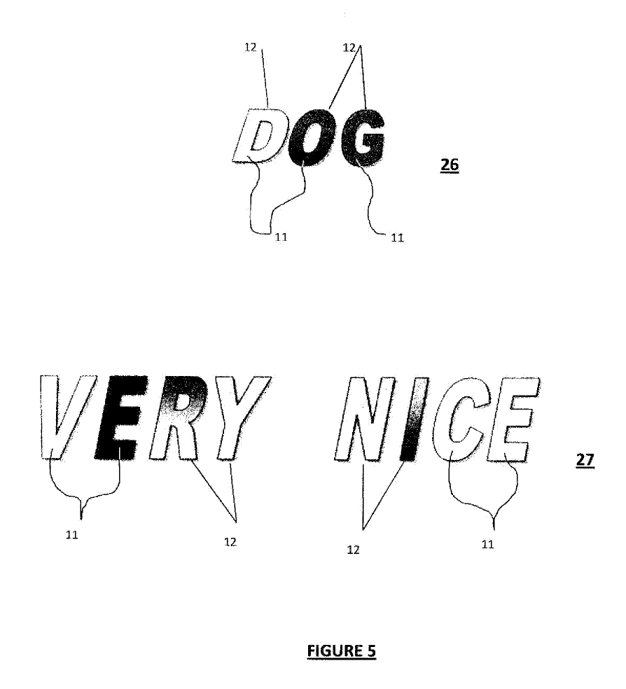

FIGS. 5-7 illustrate methods for multi-level communication utilizing the color dictionary 10 and related components described above. As will be shown, by utilizing the inventive concepts disclosed herein, a user can convey a virtually unlimited amount of information within a single message utilizing multi-level color based communication.

FIG. 5 illustrates one embodiment of multi-level color based communication, wherein a first level of communication is defined by the traditional English alphabet 12, and a second level of communication is defined by individual color patterns 11. Accordingly, a user can send a message 26 wherein the language alphabet 12 spells the word “DOG” as a first communication level, and the color patterns 11 located within the message simultaneously spell the word “CAT” as a second communication level. As another example, a user can send a message 27 wherein the language alphabet 12 spell the words “VERY NICE” as a first communication level, while the color patterns 11 simultaneously spells the words “DUMB BELL” as a second communication level.

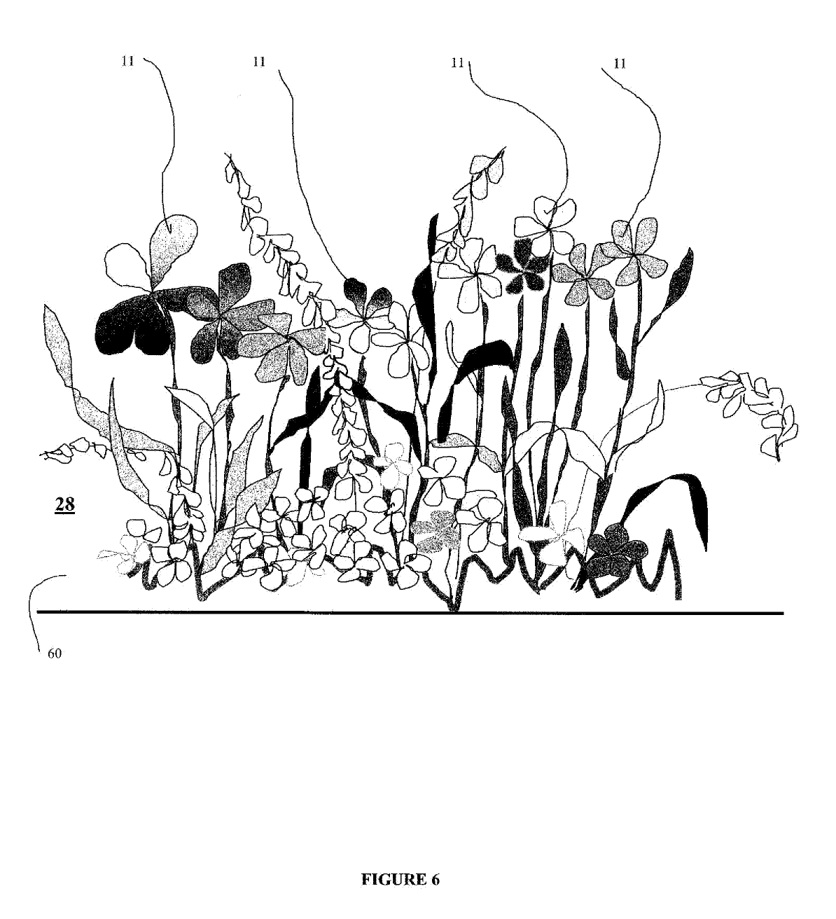

FIG. 6 illustrates another example of multi-level color based communication in which a flower arrangement 60 conveys a pleasant scene (i.e. a first communication level), and the color patterns 11 contained within the primary flower blossoms send a message 28 spelling the words “EAT MY GRITS” as a second communication level.

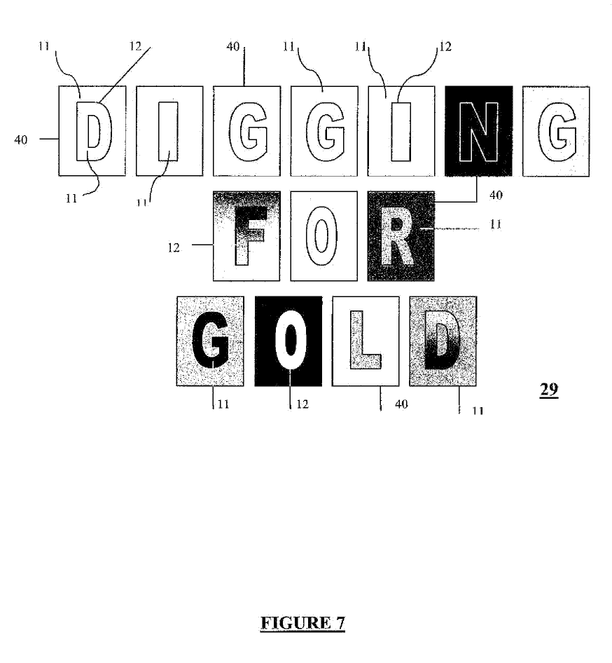

FIG. 7 illustrates yet another embodiment of multi-level color based communication wherein the above described embodiments are combined to create a third communication level within a single message. As shown, a user can send a message 29 wherein the language alphabet 12 spells the words “DIGGING FOR GOLD” as a first communication level, the color patterns 11 located within the characters of the alphabet 12 simultaneously spell the words “PICKING HIS NOSE” as a second communication level, and the color patterns 11 located within the shapes 40 surrounding the alphabet characters 12 simultaneously spell the words “LOOKING FOR SNOT” as a third communication level.

As will be apparent to those of skill in the art, the inventive concepts disclosed herein can be utilized to transmit a virtually unlimited number of distinct communication levels within a single message by combining color patterns 11 within additional letters 12 and/or shapes 40.

As described herein, the multi-level color based communication described above can be accomplished utilizing any number of known mediums. For example, the messages can be printed onto physical articles such as clothing, belts, paper, stickers, and paintings, among many others.

Alternatively, aspects of the present invention may be embodied as a system, method or computer program product. In these instances, aspects of the present invention may take the form of an entirely hardware embodiment, or an embodiment combining software (including firmware, resident software, micro-code, etc.) and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, such as wireless and wireline, for example. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention described herein with reference to illustrations and/or block diagrams of methods, apparatus (systems) and computer program products according to embodiments of the invention. It will be understood that each block of the illustrations and/or block diagrams, and combinations of blocks in the illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the illustrations and/or block diagram block or blocks.

These computer program instructions may also be stored in a computer readable medium that can direct a computer, other programmable data processing apparatuses, or other devices to function in a particular manner, such that the instructions stored in the computer readable medium produce an article of manufacture, including instructions which implement the function/act specified in the flowchart and/or block diagram block or blocks.

The computer program instructions may also be loaded onto a computer, other programmable data processing apparatuses, or other devices in order to cause a series of operational steps to be performed on the computer, other programmable apparatuses or other devices. This process can act to produce a computer implemented process such that the instructions which execute on the computer or other programmable apparatuses provide processes for implementing the functions/acts specified in the flowchart and/or block diagram block or blocks.

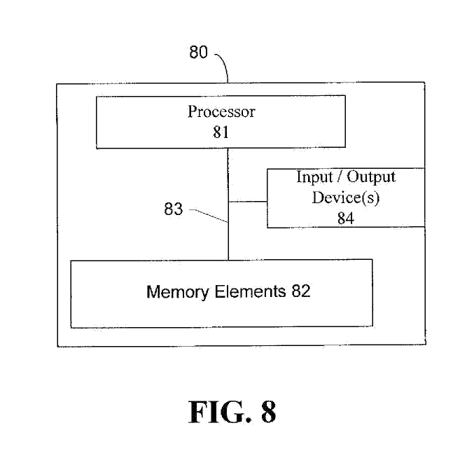

Accordingly, FIG. 8 illustrates one embodiment of a system for performing multi-level color based communication. As shown, the system 80 can include a computer system having at least one processor 81 coupled to memory elements 82 through a system bus 83 and one or more input/output devices 84. The system 80 can store program code within memory elements 82 which can be accessed by the processor 81 via the system bus 83.

Accordingly, in one embodiment, memory elements 82 can contain program language for creating multi-level color based communication when receiving a command from a user via the input/output device 84. For example, memory elements 82 can contain programming for displaying a menu of choices on a display screen. The menu can include options for specifying the number of communication levels desired to be created, the size and boundaries of any shapes 40 for containing the color patterns 11 that will ultimately display the message, and an input screen for allowing a user to enter the letters of the messages to be contained within each communication level. Upon receiving the user inputs, the processor 81 can access the color dictionary 10 stored within the memory elements 82, create the new message and display the same on the screen or other input/output unit. Moreover, the message can be transmitted to other devices in any number of known manners.

Processors, memory elements system bus and input/output units (e.g., monitors, keyboard, printer, mouse, serial port, transmitter and receiver, for example) are extremely well known in the art; therefore no further description will be provided herein.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for performing multi-level color based communication, said method comprising:
generating a set of geometric shapes, a set of colors, and a set of patterns;
associating each geometric shape of the set of geometric shapes with a character from a known language alphabet;
associating each color of the set of colors with a character from the known language alphabet;
associating each pattern of the set of patters with a character from the known language alphabet;
generating, in response to a user-supplied message, a coded message having a plurality of communication levels configured to simultaneously convey information, wherein a first communication level includes one or more individual color patterns, a second communication level includes a geometric shape, and a third communication level includes a character from a known language alphabet;
displaying the coded message, wherein each object of the coded message communicates three characters from the known language alphabet; and
wherein each step is performed by a processor executing computer readable code embodied on a non-transitory, computer readable medium.

2. (canceled)

3. (canceled)

4. The method for performing multi-level color based communication of claim 1, wherein said displaying further includes printing the coded message onto a physical medium.

5. The method for performing multi-level color based communication of claim 4, wherein said physical medium includes at least one of a shirt, belt, sticker and painting.

6. A non-transitory computer readable storage medium encoded with instructions, which when executed by a processor, causes the processor to perform a method comprising:
creating a plurality of individual color patterns;
associating each of the plurality of individual color patterns with a character from a known language alphabet;
displaying a menu requesting a number of desired communication levels from a user;
receiving the desired number of communication levels from the user;
receiving information to be displayed in each communication level; and
generating, in response to a user-supplied message, a coded message having a plurality of objects, each object generated to communicate the specified number of communication levels, wherein each of the specified number of communication levels is configured to simultaneously convey a portion of the received information, and at least one of the communication levels includes one or more individual color patterns.

7. A system, comprising:
a non-transitory memory for storing a plurality of multi-level color based communications;
at least one processor;
wherein said at least one processor is programmed or structured to:
generate a plurality of individual color patterns, associate each of the plurality of individual color patterns with a character from a known language alphabet, generate a coded message having a plurality of objects, wherein each individual object communicates three communication levels based upon an user-supplied message, wherein at least one of the communication levels includes one or more individual patterns, and wherein each communication levels conveys information; and
an input/output device configured to transmit the coded message.
